(19) United States
(12) Patent Application Publication
(10) Pub. No.: US 2026/0313005 A1
(43) Pub. Date: Oct. 8, 2026

(54) INTERNET PROTOCOL MULTIMEDIA SUBSYSTEM TRANSACTION AWARENESS TIMING

(71) Applicant: T-Mobile Innovations LLC, Overland Park, KS (US)

(72) Inventors: Khurram MIRZA, Renton, WA (US); Saqib BADAR, Bellevue, WA (US); Karthik CHANDRASEKARAN, Bellevue, WA (US); Madhuri KOTTA, Bellevue, WA (US)

(21) Appl. No.: 19/173,128

(22) Filed: Apr. 8, 2025

(51) Int. Cl. H04L 65/1016; H04L 65/1045; H04L 65/1104

(52) U.S. Cl. CPC H04L 65/1016; H04L 65/1045; H04L 65/1104

(57) ABSTRACT

Methods and systems provided herein provide for transaction awareness timing within an IP Multimedia Subsystem (IMS). Methods including receiving from an IMS core function a response to session initiation protocol (SIP) invite, the response indicating that the SIP invite has been received and is being processed. The method further includes triggering a transaction awareness timer upon receipt of the response and generating an error code upon expiration of the transaction awareness timer in the absence of a further message from the IMS core function.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, as well as 4G long-term evolution (LTE) access nodes and older legacy protocols.

During the evolution of newer wireless RATs, improved voice services have become available. For example, with 4G networks, Voice over Long-Term Evolution (VoLTE), which is an LTE high speed wireless communication standard for voice calls became available. Further, with the development of 5G networks, Voice over New Radio (VoNR), which fully utilizes the 5G standalone (SA) core network was developed. In either case, to support VoLTE or VoNR, a network must be a Voice over Packet Switched (VoPS) network utilizing an Internet Protocol (IP) Multimedia Subsystem (IMS).

### OVERVIEW

Exemplary embodiments provided herein include a method, system, processing node, and/or non-transitory computer-readable medium for Internet protocol multimedia subsystem (IMS) transaction awareness timing. In one exemplary embodiment, a method is provided. The method includes receiving, from an Internet Protocol (IP) multimedia subsystem (IMS) core function, a response to session initiation protocol (SIP) invite. The response indicates that the SIP invite has been received and is being processed. The method further includes triggering a transaction awareness timer upon receipt of the response and generating an error code upon expiration of the transaction awareness timer in the absence of a further message from the IMS core function.

In further exemplary embodiments a system is provided including a memory storing data and instructions and a processor executing the stored instructions to perform multiple operations. The operations include receiving from an Internet Protocol (IP) multimedia subsystem (IMS) core function a response to session initiation protocol (SIP) invite, the response indicating that the SIP invite has been received and is being processed. The operations further include triggering a transaction awareness timer upon receipt of the response and generating an error code upon expiration of the transaction awareness timer in absence of a further response from the IMS core function. The operations additionally include deactivating the transaction awareness timer upon receipt of a further response from the IMS core function.

In yet further embodiments, a proxy call session control function (P-CSCF) is provided. The P-CSCF includes a memory storing data and instructions and a processor executing the stored instructions to perform multiple operations. The operations include transmitting to an IMS core function, a SIP invite and receiving from the IMS core function a response to the SIP invite, the response indicating that the SIP invite has been received. The operations additionally include triggering a transaction awareness timer upon receipt of the response and generating an error code upon expiration of the transaction awareness timer in absence of a further response from the IMS core function.

In further embodiments, non-transitory computer-readable mediums or processing nodes store instructions executed by a processor to perform the operations described herein.

### BRIEF DESCRIPTION OF THE DRAWINGS

FIG. 1 depicts an exemplary environment for an IMS transaction awareness timing system in accordance with an embodiment.

FIG. 2 depicts an IMS transaction awareness timing system in accordance with an embodiment.

FIG. 3 depicts a method for performing IMS transaction awareness timing in accordance with an embodiment.

FIG. 4 depicts a further exemplary method for performing IMS transaction awareness timing in accordance with an embodiment.

FIG. 5 depicts a further exemplary method for performing IMS transaction awareness timing in accordance with an embodiment.

FIG. 6 depicts yet a further exemplary method for performing IMS transaction awareness timing in an exemplary environment in accordance with an embodiment.

### DETAILED DESCRIPTION

In embodiments disclosed herein, functionality for transaction awareness timing for the internet protocol (IP) multimedia subsystem (IMS) is provided. The IMS includes a call session control function (CSCF) with multiple components, in which the components further include a proxy call session control function (P-CSCF) that functions as an entry point for IMS traffic from user equipment (UEs) or wireless devices. The P-CSCF forwards requests to an interrogating call session control function (I-CSCF) and a serving call session control function (S-CSCF). The S-CSCF responds to requests forwarded through the P-CSCF. In response to the requests, the S-CSCF returns a message to the P-CSCF to indicate that the request is being processed. For example, in response to a session initiation protocol (SIP) invite, the S-CSCF may return a 100 trying message to the P-CSCF. This 100 trying response indicates that the SIP invite has been received by the S-CSCF and that some unspecified action is being taken on behalf of this call (for example, a database is being consulted). Generally, the 100 trying message indicates that the request is being processed and is followed by a further message or response, such as a 183 session in progress message or a 200 ok message when the request is successful. However, in some instances, the request may fail, for example, if the S-CSCF experiences an internal error or if the database is corrupted. When the request fails after the 100 trying message is sent to the P-CSCF, extensive delays can occur due to the fact that the P-CSCF is unaware of the failure. While existing SIP timers can be used to recognize failures, no existing timer addresses this particular scenario. Accordingly, a solution is needed for identifying failures at the S-CSCF or other IMS core components after the transmission of the 100 trying message to the P-CSCF.

In scenarios described herein, a transaction awareness timer is introduced in order to more quickly identify communication failures with the IMS. In embodiments provided herein, the transaction awareness timer is incorporated in or in communication with the proxy call session control function (P-CSCF). In existing scenarios, the sending of a session initiation protocol (SIP) invite may trigger a SIP timer, known as Timer B. Timer B is triggered responsive to the SIP invite to regulate the maximum amount of time that a sender will wait for an INVITE message to be acknowledged. The value of Timer B is typically determined in relation to timer T1, which provides an estimated round trip time for the SIP invite and acknowledgement process. In some existing implementations, T1 is 500 ms and Timer B is set to 64×T1. Other values are within scope of the disclosure. However, Timer B may be terminated or deactivated upon the receipt of a message from the IMS core in response to the receipt of the SIP invite. Thus, once a 100 trying message is received at the P-CSCF, Timer B is no longer effective for regulating the maximum sender waiting time.

Accordingly, embodiments provided herein include a transaction awareness timer as an additional timer for regulating a maximum waiting time after a response(e.g., a 100 trying message) to the SIP invite is received at the P-CSCF. The transaction awareness timer may be triggered upon receipt of the response (e.g., 100 trying message) at the P-CSCF. The transaction awareness timer may be terminated upon receipt of a further response at the P-CSCF. The further response may, for example, be a 183 in progress message. If the further response such as the 183 in progress message is not received within the duration of the transaction awareness timer, then the transaction awareness timing system clears the call attempted through the SIP invite and generates an error code. The duration of the transaction awareness timer may be set based on network characteristics, but should be less than the duration of Timer B.

The transaction awareness timer is operable to activate a failure call flow when IMS core components experience an internal error or other circumstance in which they are unable to provide a normal call flow after receiving the SIP invite and sending a response such as a 100 trying message to the P-CSCF. In certain circumstances, the S-CSCF may send a response, but may be unable to process a VoLTE or VoNR call due to internal issues or due to issues with other components. After the S-CSCF has sent the response to the P-CSCF, multiple additional calls during this time may fail as the session border gateway (SBG) is unaware that the call failure and internal issue at the S-CSCF. Accordingly, in order to facilitate failure recognition to avoid further failures, embodiments provided herein add transaction awareness intelligence to the P-CSCF to recognize call failures at the IMS core.

In operation, a wireless device sends a SIP invite toward an access node and the access node forwards the SIP invite through the core network to the P-CSCF. The P-CSCF sends the invite to the IMS core, where it reaches the S-CSCF. The S-CSCF may return a 100 trying response immediately and upon receipt of this response at the P-CSCF, the transaction awareness timer is triggered. The S-CSCF and P-CSCF operate as server and client respectively. In some instances, the S-CSCF may be unable to process the call associated with the SIP invite due to an internal issue. When the S-CSCF is unable to process the call through the duration of the transaction awareness timer, the transaction awareness timer expires and an error message is generated. The call fails and may, in some instances, be directed to voicemail. In other instances, after the transaction awareness timer is triggered, the S-CSCF is able to process the call and sends a further response, such as a 183 in progress message to the P-CSCF. At this point, the timer is de-activated or terminated and the call succeeds.

Embodiments of the transaction awareness timing system provided herein facilitate quicker failure in the above-described situations as faster failure of a call currently being processed will prevent additional failures from occurring during the period in which the caller is waiting for the failure to occur. In order to implement the solution, the transaction awareness timer may be a configurable timer with a duration shorter than that of Timer B. For example, if Timer B has a duration of thirty two seconds, the transaction awareness timer may have a duration of anywhere between three and thirteen seconds. A network operator may configure the timer based on existing network parameters.

Further, in embodiments provided herein, a transaction awareness timing system sends a cancel message to the P-CSCF when the timer expires. The P-CSCF may then generate and send an error code to the S-CSCF and also to the originating wireless device. The error code may be sent, for example, with a timeout 408 message. Accordingly, the P-CSCF or the transaction awareness timing system communicating with or incorporated in the P-CSCF may inform both the device and the network that the session associated with the SIP invite has been released.

Configurable actions may be implemented upon release. For example, the release may be associated with a voicemail or simply an announcement that the receiving party is unreachable or unavailable. To implement a voicemail, the P-CSCF may notify the core network, so that the core network can trigger the voicemail process.

In addition to the systems and methods described herein, non-transitory computer-readable mediums may store the operations for the instructions or methods. Further, processing nodes on the network may execute the instructions or methods.

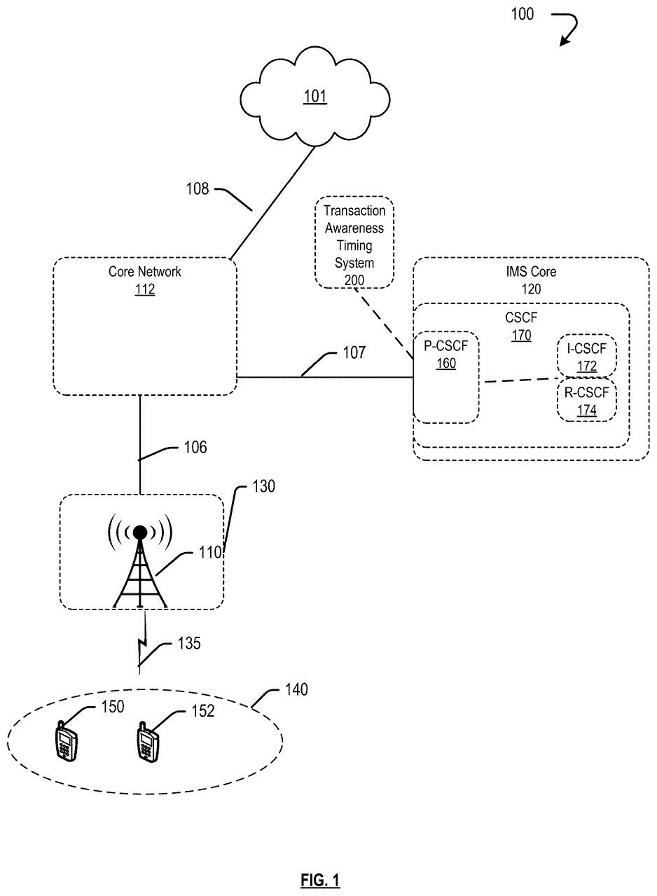

FIG. 1 depicts an exemplary environment 100 for implementing a transaction awareness timing system 200. Environment 100 comprises a communication network 101, core network 112, and a radio access network (RAN) 130 including at least an access node 110. Wireless devices 150 and 152 are located in a coverage area 140 and communicate with the access node 110 over a communication link 135. Although only two wireless devices 150 and 152 are shown, it should be understood that any number of wireless devices could be included. Further, an IP multimedia subsystem (IMS) 120 is connected to the core network 112. The IMS 120 includes a call session control function (CSCF) 170 including an interrogating call session control section (I-CSCF) 172, a serving call session control function (S-CSCF) 174 and a proxy call session control function (P-CSCF). While both the core network 112 and the IMS 120 include additional features, these features are omitted for the purposes of explanation and simplification.

Further, transaction awareness timing system 200 interacts with the IMS 120 to operate based on requests received from wireless devices 150, 152 at the P-CSCF 160. The P-CSCF 160 further interacts with the I-CSCF 172 and the S-CSCF 174. The transaction awareness timing system 200 is illustrated as communicating with or incorporated in the P-CSCF 160 or the IMS 120.

In operation, the wireless device 150 sends a SIP invite over wireless communication link 135 to an access node 110 of the RAN 130. The SIP invite ultimately reaches the P-CSCF 160. In response to the SIP invite, the P-CSCF 160 communicates with the I-CSCF 172 and S-CSCF 174 to establish a session with another wireless device, such as the wireless device 152.

The P-CSCF 160 acts as the ingress and egress point to and from the IMS 120 and thus acts as a SIP proxy for the IMS 120. Requests originating from wireless devices 150, 152, pass through the P-CSCF 160 before accessing the services of the IMS 120. The P-CSCF 160 interacts with the I-CSCF 172 and/or a serving S-CSCF 174.

The P-CSCF 160 is responsible for onward routing of registration and session requests to the correct nodes in the network, ensuring the S-CSCF 174 is kept updated on the access network 130 providing session information to the core network 112 and maintaining a secure connection with the wireless devices 150, 152. The P-CSCF 160 can inspect all signals and provide authentication. The I-CSCF 172 retrieves the address of the S-CSCF 174 and assigns it to a wireless device performing SIP registration. The I-CSCF 172 also forwards the SIP request or response to the S-CSCF 174. The S-CSCF 174 is a SIP server that performs session control and handles SIP registrations. The S-CSCF 174 decides to which application server the SIP message will be forwarded, in order to provide their services.

The RAN 130 can include various access network functions and devices disposed between the core network 112 and the wireless devices 150, 152. For example, the RAN 130 includes at least an access node (or base station), such as an eNodeB and/or a next generation NodeB (gNodeB) 110 communicating with the wireless devices 150, 152. Further, either of core network 112 and RAN 130 can include one or more of a local area network, a wide area network, and an internetwork (including the Internet) and be capable of communicating signals and carrying data, for example, to support voice, push-to-talk, broadcast video, and data communications by the wireless devices 150, 152.

Access node 110 can be any network node configured to provide communication between the wireless devices 150, 152 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is an eNB or gNB. However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 150, 152 are illustrated in FIG. 1, any number of access nodes 110 and wireless devices 150, 152 can be implemented within environment 100.

As further described herein, by utilizing antennas, access node 110 can deploy a communication link 135 using one or more frequency bands over one or more coverage areas 140. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless devices 150, 152 may be any device, system, combination of devices, or other such communication platform capable of communicating wirelessly with access node 110 using one or more frequency bands deployed therefrom. Wireless devices 150, 152 may be, for example, a mobile phone, a wireless phone, a wireless modem, a personal digital assistant (PDA), a voice over internet protocol (VoIP) phone, a voice over packet (VOP) phone, a soft phone as well as other types of devices or systems that can exchange audio or data via access node 110. The wireless devices 150, 152 can be end-user wireless devices (e.g., user equipment (UEs)) utilizing communication links 135, which may operate based on 6G, 5G new radio (NR), 4G long term evolution (LTE), or any other suitable type of ratio access technology (RAT).

The core network 112 may include a service based architecture (SBA) architecture, in which service-based interfaces may be utilized between control plane functions, while multiple user plane functions connect over point-to-point link. Each network function may expose its functionality through a Service-Based Interface (SBI). The core network 112 may alternatively or additionally have an evolved packet core (EPC) structure.

Communication links 107, 108, and 109 can use various communication media, such as air, space, metal, optical fiber, or some other signal propagation path-including combinations thereof. Communication links 107, 108, and 109 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication links 107, 108, and 109 can be a direct link or might include various equipment, intermediate components, systems, and networks. Communication links 107, 108, and 109 may comprise many different signals sharing the same link.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices. Wireless network protocols can comprise MBMS, code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other wireless network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM), and/or other wired network protocols. Communication network 101 can also comprise additional base stations, controller nodes, telephony switches, internet routers, network gateways, computer systems, communication links, or some other type of communication equipment, and combinations thereof.

Other network elements may be present in environment 100 to facilitate communication but are omitted for clarity, such as base stations, base station controllers, mobile switching centers, dispatch application processors, network functions, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

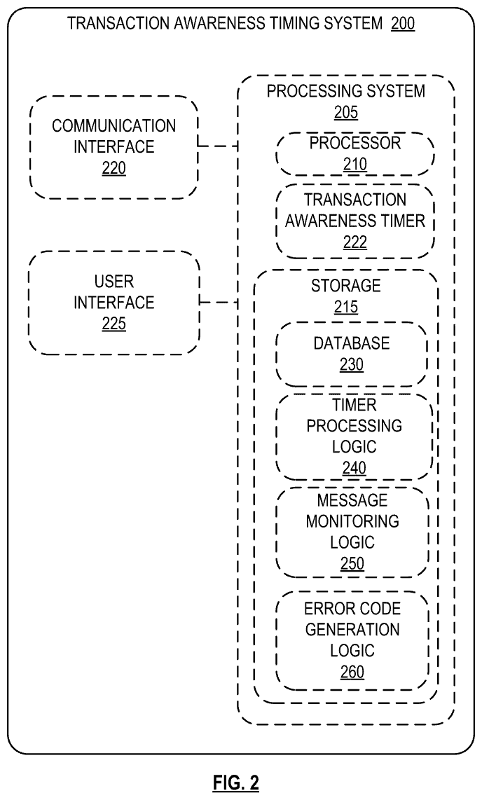

FIG. 2 illustrates a transaction awareness timing system 200 in accordance with embodiments described herein. The components described herein are merely exemplary as many different configurations for the transaction awareness timing system 200 may be implemented. The transaction awareness timing system 200 may be configured to perform the methods and operations disclosed herein to dynamically identify failures occurring after transmission of a SIP invite from the P-CSCF 160 to the I-CSCF 172 and S-CSCF 174.

Thus, the transaction awareness timing system 200 may interact with the P-CSCF 160 of the IMS 120 to ensure that failures are detected in a timely manner from the P-CSCF 160. In the disclosed embodiments, the transaction awareness timing system 200 may be integrated with the P-CSCF 160 or may be an entirely separate component capable of communicating with the P-CSCF 160. Further, the components of the transaction awareness timing system 200 may be distributed so that one or more components are located within the P-CSCF 160, and/or a separate processing node in communication with or integrated with the P-CSCF 160.

The transaction awareness timing system 200 may be configured for performing the operations described herein utilizing a processing system 205. Processing system 205 may include a processor 210 and a storage device 215, and a transaction awareness timer 222. The transaction awareness timer 222 may have a configurable duration. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

Timer processing logic 240 may allow for configuration of the transaction awareness timer 222 and further may interact with message monitoring logic 250 and error code generation logic 260. The message monitoring logic 250 may track the sending of a SIP invite and further monitor for received messages subsequent to the sending of the SIP invite. For example, the message monitoring logic 250 may detect the sending of a SIP invite and monitor for receipt of a 183 in progress message. Upon detecting a 183 in progress message while the transaction awareness timer 222 is running, the message monitoring logic 250 may notify the timer processing logic 240 so that the timer processing logic 240 can terminate the transaction awareness timer 222. Finally, the error code generation logic 260 interacts with the timer processing logic 240 to generate an error code when no message is received prior to expiration of the transaction awareness timer 222. Further, the storage device 215 may include a database 230. To perform the above-described operations, the timer processing logic 240, the message monitoring logic 250 and the error code generation logic 260 may be executed by the processor 210 to proactively manage failures of the I-CSCF 172, S-CSCF 174 or other IMS core components.

Processor 210 may be a microprocessor and may include hardware circuitry and/or embedded codes configured to retrieve and execute software stored in storage device 215. The transaction awareness timing system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the transaction awareness timing system 200 and receive data or information from other system components. User interface 225 may include hardware components, such as touch screens, buttons, displays, speakers, etc. The transaction awareness timing system 200 may further include other components such as a power management unit, a control interface unit, etc. The location of the transaction awareness timing system 200 may depend upon the network architecture. As set forth above, the transaction awareness timing system 200 may be located in a separate processing node, in the P-CSCF 160, or elsewhere in the IMS 120. Further, although shown as a single integrated system, the functions of the transaction awareness timing system 200 may be separated and be disposed in separate locations.

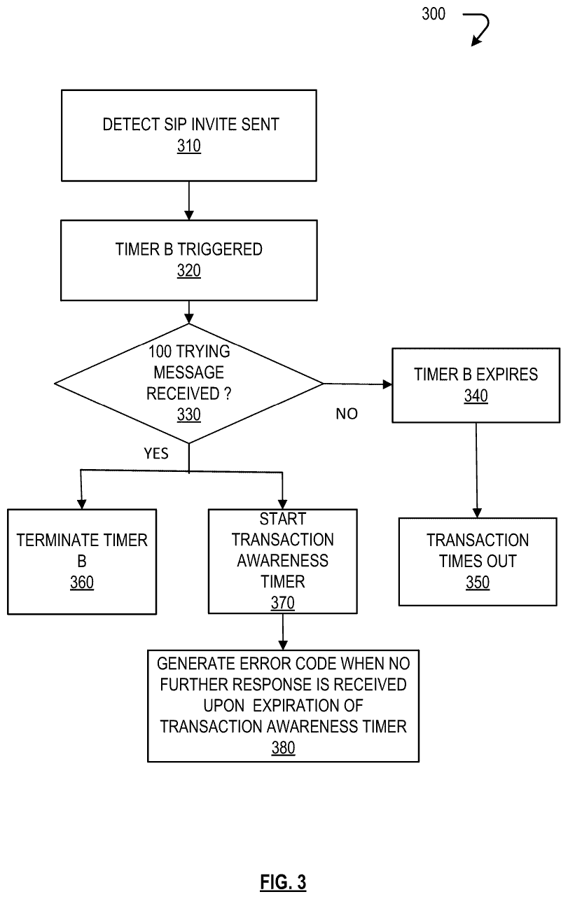

FIG. 3 illustrates a generalized exemplary method 300 for operating a transaction awareness timing system 200 in accordance with embodiments provided herein. Some steps of method 300 may be performed by a processor, for example, the processor 210 included in the transaction awareness timing system 200, or a processor in the P-CSCF 160. For discussion purposes, as an example, various steps of method 300 are described as being performed by the processor 210 of the transaction awareness timing system 200. However, it should be understood that the steps illustrated in FIG. 3 are performed in conjunction with the P-CSCF 160 and the processor 210 may, in fact, be incorporated in the P-CSCF 160. Additionally, some steps of the method 300 are performed by other components within the network

Method 300 starts in step 310, in which the processor 210 detects the transmission of a SIP invite in step 310. Upon transmission of the SIP invite, timer B is triggered in step 320. Timer B indicates a maximum amount of time allowed for acknowledgement of a SIP invite.

In step 330, the processor 210 monitors received messages to determine if a further message in response to the SIP invite, such as a 100 trying message, has been received before timer B expires, for example from the S-CSCF 174 at the P-CSCF 160. If no 100 trying message is received in step 330, then timer B expires in step 340 and the transaction times out in step 350. Timing out of the transaction in step 350 indicates that the attempted call has failed and no session is established.

However, if a further message in response to the SIP invite, such as a 100 trying message, is received in step 330 during the duration of timer B, timer B is terminated in step 360 and the processor 210 triggers the transaction awareness timer 222 in step 370. Finally, in step 380, the processor 210 generates an error code when no further response is received upon expiration of the transaction awareness timer 222 in step 380.

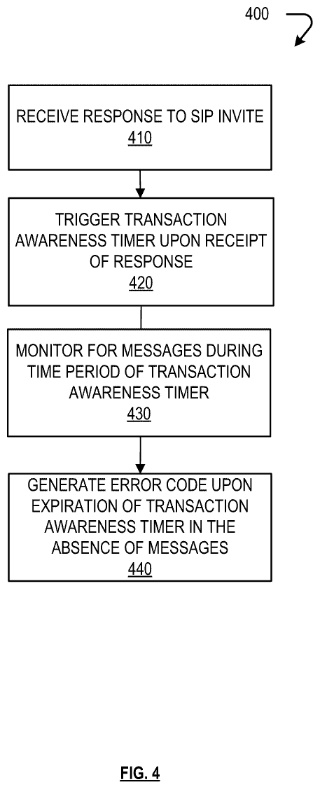

FIG. 4 depicts a further exemplary method 400 for transaction awareness timing in accordance with embodiments disclosed herein. Method 400 may be performed by any suitable processor discussed herein, for example, the processor 210 included in the transaction awareness timing system 200 or a processor in the P-CSCF 160. For discussion purposes, as an example, method 400 is described as being performed by the processor 210 included in the transaction awareness timing system 200, which may be wholly or partially incorporated in the P-CSCF 160.

Method 400 starts in step 410, in which the processor 210 receives a response or a notification of response to a SIP invite. The response may be received, for example, at the P-CSCF 160 from the S-CSCF 174 and the response may be in the form of a 100 trying message. In step 420, the processor 210 may trigger the transaction awareness timer 222 upon receipt of the response or upon notification of receipt of the response.

In step 430, the processor 210 may monitor for received messages in response to the SIP invite during the timer period of the transaction awareness timer 222. For example, the processor 210 may monitor for messages such as 183 in progress message during the time period of the transaction awareness timer 222.

Finally, in step 440, the processor 210 causes an error code to be generated upon the expiration of the transaction awareness timer 222 in the absence of any responsive messages to the SIP invite. Thus, when the P-CSCF 160 does not receive any responses to the SIP invite during the time period of the transaction awareness timer 222, an error code is generated in step 440.

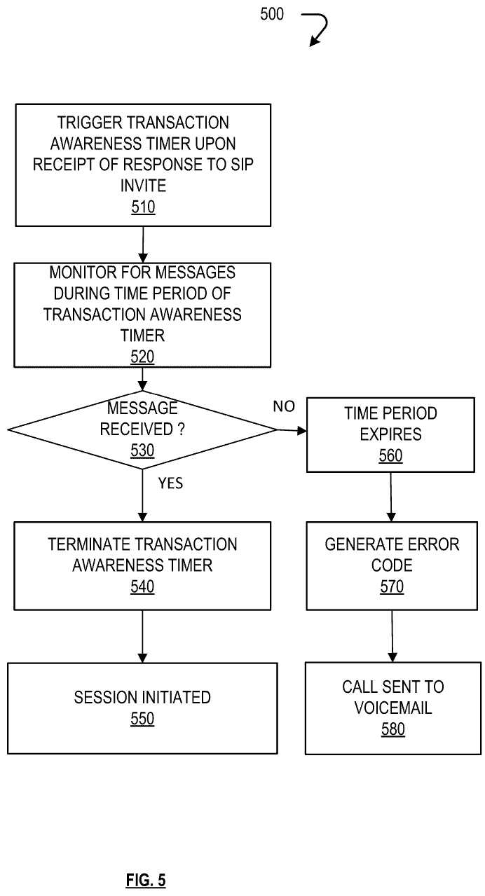

FIG. 5 depicts an additional exemplary method 500 for operation of the transaction awareness timing system 200 in accordance with embodiments disclosed herein. Method 500 may be performed by any suitable processor discussed herein, for example, the processor 210 in the transaction awareness timing system 200, which may be wholly or partially incorporated in the P-CSCF 160 or in a separate processing node. For discussion purposes, as an example, method 500 is described as being performed by the processor 210 included in the transaction timing awareness system 200.

In step 510, the processor 210 triggers the transaction awareness timer 222 upon receipt of a response at the P-CSCF 160 to a SIP invite. The response may, for example, be a 100 trying message.

In step 520, the processor 210 monitors for messages during a period of the transaction awareness timer 222. The message may be a further response conveying information about processing of the SIP invite, such as a 183 in progress message. If a message is received in step 530 before the expiration of the transaction awareness timer 222, the processor 210 terminates or deactivates the transaction awareness timer 222 in step 540. The message may be or include a further response to the SIP invite such as a 183 in progress message. Other messages such as 181 call forwarded, 182 Queued, and 200 okay may terminate the transaction awareness timer 222. Thus, in embodiments provided herein, the response to the SIP invite is a 100 trying message, wherein the 100 trying message triggers the transaction awareness timer and the 183 message deactivates the transaction awareness timer.

However, if no message is received in step 530, the time period of the transaction awareness timer 222 expires in step 560. Thus, the transaction awareness timer 222 expires after receipt of the 100 trying message but prior to receipt of a 183 message. The expiration of the transaction awareness timer 222 indicates an IMS core error and triggers generation of an error code in step 570. Generation of the error code may cause the call associated with the SIP invite to be sent to voicemail in step 580. Other configurable actions may additionally or alternatively be taken.

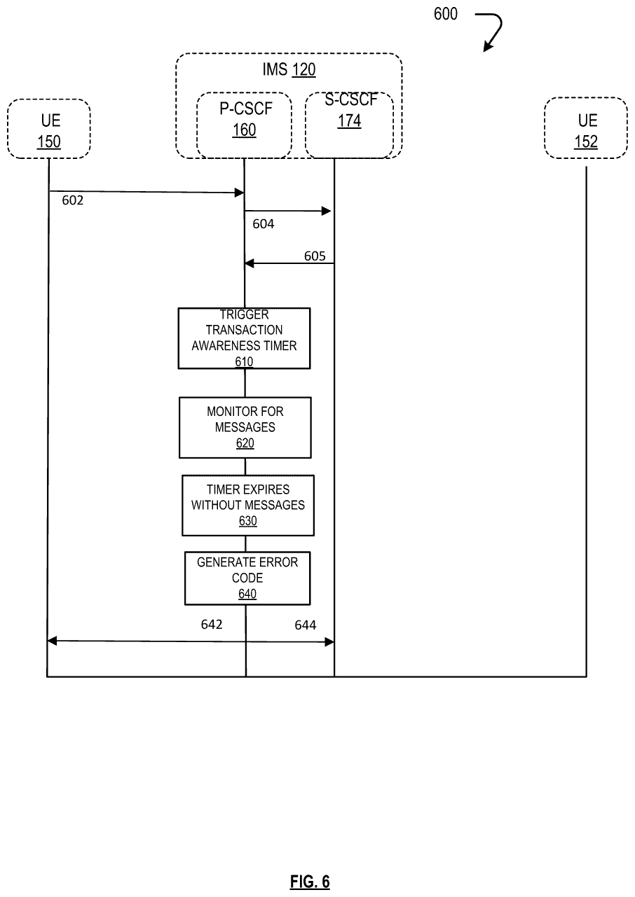

FIG. 6 illustrates a method 600 for transaction awareness timing including interactions between the wireless device 150, an IMS including a P-CSCF 160 and S-CSCF 174, and the wireless device 152. It should be noted that other components may participate in the process have been omitted for the purposes of explanation and simplification. As explained above, the transaction awareness timing system 200 may be a discrete node operating in conjunction with the displayed components. The transaction awareness timing system 200 may alternatively be partially or wholly incorporated in the P-CSCF 160.

In step 602, the wireless device 150 attempts to make a voice call, such as a VoLTE or VoNR call to the wireless device 152, by sending a SIP invite in step 602 towards the P-CSCF 160. While an access node and core network are also involved in the process, they are omitted for simplification. In step 604, the P-CSCF 160 forwards in the SIP invite to the S-CSCF 174. In response, in step 605, the S-CSCF 174 responds with a 100 trying message to the P-CSCF 160.

In response to the 100 trying message, in step 610, the transaction awareness timer 222 is triggered. In step 620, the transaction awareness timing system 200 monitors for a further response from the S-CSCF 174, such as a 183 in progress message. In step 630, the transaction awareness timer 222 expires without any further responses having been detected. Expiration of the timer in step 630 triggers generation of an error code in step 640, which may be conveyed by the transaction awareness timing system 200 to the P-CSCF 160. Upon generation of the error code, further steps may be taken to allow for voicemail redirection or otherwise providing an indication of unavailability of the call recipient. For example, the P-CSCF 160 may send an error code, such as timeout 408, back to the S-CSCF 174 in step 644. The P-CSCF 160 may further send the error code to the wireless device 150 at step 642, to let the wireless device know the session has been released.

Accordingly, as set forth above, embodiments providing for transaction awareness timing are disclosed. In some embodiments, methods 300, 400, 500, and 600 may include additional steps or operations and additional network components. Furthermore, the methods may include steps shown in each of the other methods. Additionally, the order of steps shown is merely exemplary and the steps may be re-ordered as appropriate. As one of ordinary skill in the art would understand, the methods 300, 400, 500, and 600 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving from an Internet Protocol (IP) multimedia subsystem (IMS) core function a response to session initiation protocol (SIP) invite, the response indicating that the SIP invite has been received and is being processed;
triggering a transaction awareness timer upon receipt of the response; and
generating an error code upon expiration of the transaction awareness timer in the absence of a further message from the IMS core function.

2. The method of claim 1, wherein the response is a 100 trying message in response to the SIP invite.

3. The method of claim 1, wherein the response is received from serving call session control function (S-CSCF).

4. The method of claim 1, wherein the response is received by a proxy call session control function (P-CSCF).

5. The method of claim 1, further comprising deactivating the transaction awareness timer upon receipt of a further response conveying information about processing of the SIP invite.

6. The method of claim 5, wherein the further response is a 183 message.

7. The method of claim 1, wherein the response is a 100 trying message and the transaction awareness timer is activated upon receipt of the 100 trying message and expires prior to receipt of a 183 in progress message.

8. The method of claim 1, wherein expiry of the transaction awareness timer indicates an IMS core error.

9. The method of claim 1, further comprising utilizing Timer B indicating a maximum amount of time allowed for acknowledgement of a SIP invite.

10. The method of claim 9, further comprising setting a value of the transaction awareness timer to be shorter than a value of Timer B.

11. A system comprising:
a memory storing data and instructions;
a processor executing the stored instructions to perform operations including:
receiving from an Internet Protocol (IP) multimedia subsystem (IMS) core function a response to session initiation protocol (SIP) invite, the response indicating that the SIP invite has been received and is being processed;
triggering a transaction awareness timer upon receipt of the response;
generating an error code upon expiration of the transaction awareness timer in absence of a further response from the IMS core function; and
deactivating the transaction awareness timer upon receipt of the further response from the IMS core function.

12. The system of claim 11, wherein the response is a 100 trying message in response to the SIP invite.

13. The system of claim 11, wherein the response is received from a serving call session control function (S-CSCF).

14. The system of claim 11, wherein the response is received by a proxy call session control function (P-CSCF).

15. The system of claim 11, wherein the further response is a 183 in progress message.

16. The system of claim 15, wherein the response is a 100 trying message, wherein the 100 trying message triggers the transaction awareness timer and the 183 in progress message deactivates the transaction awareness timer.

17. The system of claim 16, wherein expiry of the transaction awareness timer occurs prior to receipt of the 183 in progress message to trigger generation of the error code.

18. A proxy call session control function (P-CSCF) comprising:
a memory storing data and instructions; and
a processor executing the stored instructions to perform operations including:
transmitting to an Internet Protocol (IP) multimedia subsystem (IMS) core function, a session initiation protocol (SIP) invite;
receiving from the IMS core function a response to the SIP invite, the response indicating that the SIP invite has been received;
triggering a transaction awareness timer upon receipt of the response; and
generating an error code upon expiration of the transaction awareness timer in absence of a further response from the IMS core function.

19. The P-CSCF of claim 18, the operations further comprising deactivating the transaction awareness timer upon receipt of the further response from the IMS core function.

20. The P-CSCF of claim 18, wherein a call related to the SIP invite is sent to voicemail upon generation of the error code.
